(19) United States
(12) Patent Application Publication
(10) Pub. No.: US 2012/0101776 A1
(43) Pub. Date: Apr. 26, 2012

(54) EMBEDDED PROGNOSTIC HEALTH MANAGEMENT SYSTEM FOR AERONAUTICAL MACHINES AND DEVICES AND METHODS THEREOF

(76) Inventors: Alfred N. Brower, Bridgewater, NJ (US); Robert F. Franz, Bridgewater, NJ (US)

(21) Appl. No.: 12/912,512

(22) Filed: Oct. 26, 2010

(51) Int. Cl. G06F 15/00

(52) U.S. Cl. 702/183

(57) ABSTRACT

Embodiments of the present invention relate to a system for monitoring the characteristics of key components of aeronautical machines (e.g., airplanes, helicopters, etc.), processing obtained data, and delivering prognostic health indicators to improve machine performance and detect early warning signs of failure. In one embodiment, a method of maintaining prognostic health management accuracy of an aeronautic system comprises providing a control module and a sensor pod having a plurality of sensors, and physically positioning the plurality of sensors on a mechanical component of an aircraft; obtaining operational data from the sensors while the aircraft is operating in a native environment; transmitting operational data to the control module and determine real-time system performance characteristics; processing real-time system performance characteristics against a set of historical records containing past system performance characteristics and generating predictive indicators for forecasting remaining component lifetime and future component failures; and providing predictive indicators on an indicator means.

### FEDERALLY SPONSORED RESEARCH AND DEVELOPMENT

This invention was made with United States Government support under SBIR AF 0811 awarded by the United States Air Force. The United States Government may have certain rights in the invention.

### BACKGROUND

1. Field of the Invention

Embodiments of the present disclosure generally relate to an embedded prognostic health management system for aeronautical machines and devices and method of utilizing the same. More specifically, embodiments of the present invention relate to a system for monitoring the physical characteristics of key components of aeronautical machines (e.g., airplanes, helicopters, etc.), processing obtained data, and delivering prognostic health indicators to improve machine performance and detect early warning signs of failure.

2. Description of Related Art

The aeronautical industry faces major financial challenges and changes that currently motivate cost avoidance measures. Maintenance errors are responsible for a significant percentage of accidents in this sector. While failure to diagnose and correct a problem can be disastrous, overly conservative maintenance scheduling reduces operational availability and prematurely disposes of functioning units thus increasing life cycle costs.

To provide added value for the maintenance process, Prognostic Health Management (PHM) approaches must estimate the remaining life of a Line Replaceable Unit (LRU) in a timeframe suitable for corrective action within a distributed maintenance decision-making environment. The estimated annual global market for diagnostic tools within commercial aviation maintenance is in excess of $1 billion, indicating a significant need in the industry for improved technology for reducing failures and decreasing life cycle costs.

There are numerous systems currently available that attempt to provide prognostic health management and diagnostic capabilities within the aeronautical industry. While these solutions may provide suitable diagnostic solutions for immobile or stagnant components and attributes of an operational aeronautic system, these solutions are highly unreliable when measuring active, rapidly moving and/or high-noise (i.e., interference) components of the aeronautic system.

As such, there is a need for an embedded prognostic health management system for aeronautical machines and devices and method of utilizing the same.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level diagram of system for prognostic health monitoring in accordance with one embodiment of the present invention;

FIG. 2 depicts a control module in accordance with another embodiment of the present invention;

FIG. 3 depicts an exploded view of an exemplary control module in accordance with an embodiment of the present invention;

FIG. 4 depict a perspective view of a jet engine, having a prognostic health monitoring system embedded therein, in accordance with embodiments of the present invention; and

FIG. 5 depicts a flowchart of a method of operation of an embedded prognostic health management system for aeronautical machines in accordance with embodiments of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the Figures.

### SUMMARY

Embodiments of the present disclosure generally relate to an embedded prognostic health management system for aeronautical machines and devices and method of utilizing the same. More specifically, embodiments of the present invention relate to a system for monitoring the physical characteristics of key components of aeronautical machines (e.g., airplanes, helicopters, etc.), processing obtained data, and delivering prognostic health indicators to improve machine performance and detect early warning signs of failure.

In one embodiment of the present invention, a method of maintaining prognostic health management accuracy of an aeronautic system comprises providing a control module and a sensor pod having a plurality of sensors, and physically positioning the plurality of sensors on a mechanical component of an aircraft; obtaining operational data from the sensors while the aircraft is operating in a native environment; transmitting operational data to the control module and determine real-time system performance characteristics; processing real-time system performance characteristics against a set of historical records containing past system performance characteristics and generating predictive indicators for forecasting remaining component lifetime and future component failures; and providing predictive indicators on an indicator means.

In another embodiment of the present invention, a method of maintaining prognostic health management accuracy of a jet comprises providing a control module and a sensor pod having a plurality of sensors, and physically positioning the plurality of sensors on a mechanical component of a jet engine; obtaining operational data from the sensors while the jet is operating in a native environment; interfacing with an existing traditional transducer-based measurement system and obtaining traditional data therefrom; transmitting operational data and traditional data to the control module and determine real-time system performance characteristics; processing real-time system performance characteristics against a set of historical records containing past system performance characteristics and generate predictive indicators for forecasting remaining component lifetime and future component failures; provide predictive indicators on an indicator means; generating real time control signals to actively limit a range of use parameter to enforce operational safety limitations; and reporting predictive indicators to at least one external supervisory management system.

In yet another embodiment of the present invention, a system for maintaining prognostic health management accuracy of an aeronautic system comprises a control module in communication with a sensor pod, the sensor pod having a plurality of sensors positioned on a mechanical component of an aircraft; and a set of executable instructions stored within a memory in the control module, the set of executable instructions for: obtaining operational data from the sensors while the aircraft is operating in a native environment; transmitting operational data to the control module and determine real-time system performance characteristics; processing real-time system performance characteristics against a set of historical records containing past system performance characteristics and generating predictive indicators for forecasting remaining component lifetime and future component failures; and providing predictive indicators on an indicator means.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to an embedded prognostic health management system for aeronautical machines and devices and method of utilizing the same. More specifically, embodiments of the present invention relate to a system for monitoring the physical characteristics of key components of aeronautical machines (e.g., airplanes, helicopters, etc.), processing obtained data, and delivering prognostic health indicators to improve machine performance and detect early warning signs of failure.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

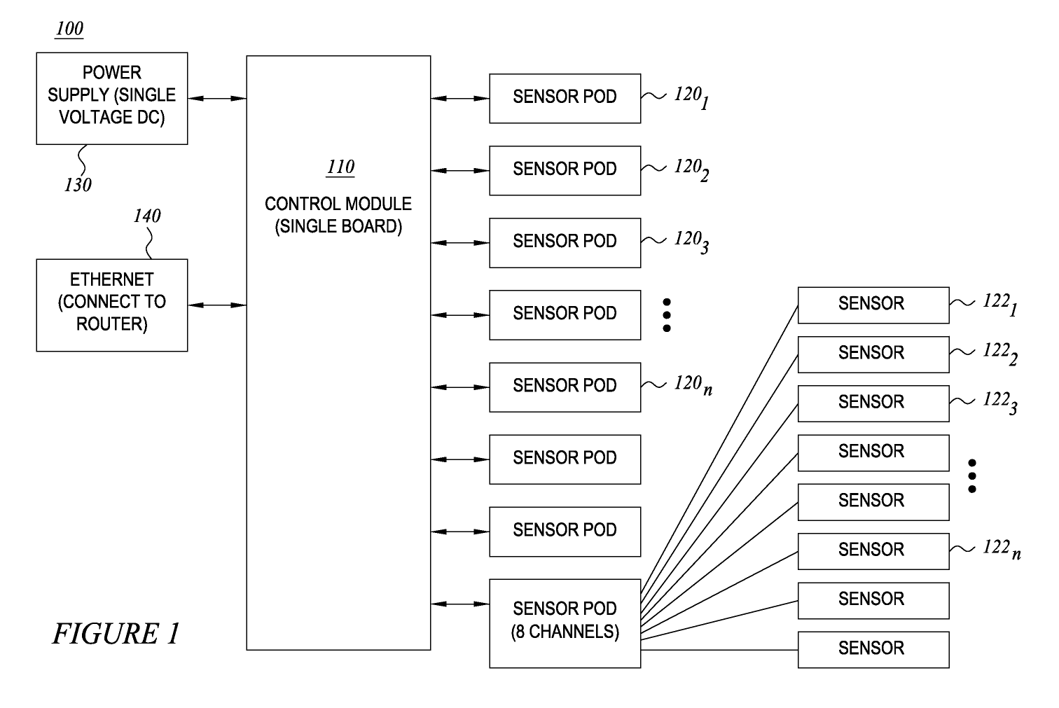

FIG. 1 depicts a system-level diagram of system for prognostic health monitoring in accordance with one embodiment of the present invention. The system 100 generally comprises a control module 110 and at least one sensor pod 120 having at least one sensor 122 in communication therewith. It should be appreciated by embodiments of the present invention, any number of sensor pods 120₁₋ₙ may be provided, where n represents any number of sensor pods feasible in accordance with embodiments of the present invention. For ease of reference, as used herein, the term “sensor pod(s)” may refer to any one or all of the sensor pods 120₁₋ₙ within the system 100 and may be generally referenced as sensor pod 120. Similarly, each sensor pod 120 may be in communication with any number of sensors 122₁₋ₙ, where n represents any number of sensors feasible in accordance with embodiments of the present invention. The term “sensor” may refer to any one or all of the sensors 122₁₋ₙ within the system 100 and may be generally referenced as sensor 122.

The control module 110 generally acts as a central hub for receiving, processing, and transmitting data through the system 100, and is discussed in greater detail below. Often, the control module 110 requires an outside power source, such as a power supply 130. The power supply 130 may comprise any type of power source suitable for embodiments of the present invention. In some embodiments, the power supply comprises one of an AC or DC standardized power source. In one such embodiment, the power supply comprises a 24V DC power source. The power supply 130 may be provided in any form suitable for embodiments of the present invention. For example, the power supply 130 may be provided as common in-wall power, a rechargeable battery, an alternator-type device for generating power from rotational components of an aircraft (as described hereinbelow), or the like.

In many embodiments of the present invention, the control module is in communication with an administrator (not shown) through a network 140. The network 140 may comprise any network suitable for embodiments of the present invention. For example, the network 140 may be a partial or full deployment of most any communication/computer network or link, including any of, any multiple of, any combination of or any combination of multiples of a public or private, terrestrial wireless or satellite, and wireline networks or links. The network 140 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

The sensor pods 120 generally serve to act as an interface to improve performance of the system 100 by allowing for close proximity with the sensors 122 and provide signal transport over digital means. In some embodiments, it may be desirable to position the sensor pods 120 as close to the location of the sensor 122 as is thermally possible (i.e., before failure due to thermal exposure). Generally, the frequency band of each pod can vary from DC to over 90 kHz. In many embodiments, where the sensors 122 are analog, the sensor pods 120 improve the analog performance of the system 100 because of the close proximity to the sensors 122, minimizing undesired interference and noise within the system 100. The sensor pods 120 may also process control and synchronization data sent by the control module 110 to each of the sensors 122.

The sensor pods 120 may comprise a plurality of channels, each channel for communicating with a sensor 122. In one exemplary embodiment, the sensor pods 120 comprise 8-channels, thus accommodating 8 sensors 122. Often, each sensor pod 120 is dedicated to a single type of sensor 122, and as such, may not utilize all of its channels during operation.

The sensors 122 may comprise any type of sensors suitable for embodiments of the present invention. Whereas embodiments of the present invention are designed to provide prognostic health maintenance of aeronautical machines, any number of types of sensors may be useful for obtaining operational data from the machine components. In one embodiment, the sensors 122 comprise any one of an acceleration sensor (e.g., accelerometer, etc.), a linear/angular position sensor (e.g., potentiometer, encoder, linear/rotational variable differential transformer, etc.), a chemical/gas sensor (e.g., electromechanical, infrared, thermal conductivity, etc.), a humidity/moisture sensor, a flow rate sensor (e.g., venuturi valve, pitot tube, flow transducer, etc.), a force sensor (e.g., load cell, strain gauge, etc.), a magnetic sensor (e.g., magnetoresistive, etc.), a pressure sensor (e.g., pressure transducer, piezoresistive, etc.), proximity/spacial sensors (e.g., inductive proximity, capacitive, photoelectric, ultrasonic, etc.), a sound sensor (e.g., sound intensity microphone, etc.), a temperature sensor (e.g., thermocouples, thermoresistors, etc.), velocity sensors (e.g., linear velocity transducer, tachometer, etc.), combinations thereof or the like. In one specific embodiment, the sensors 122 comprise piezo vibration sensors, such as those commercially available from PCB Piezotronics, Inc., of Depew, N.Y., sold as PCB Piezotronics 301A10.

The sensors 122 may be in communication with the sensor pods 120 utilizing any known means of wired or wireless communication. Whereas the type of communication may be dependent upon the type of sensor, the positioning of the sensor within the system, and other external factors, embodiments of the present invention appreciate any known type of communication may be feasible within the context of embodiments of the present invention.

The data link between the sensor pods 120 and the control module 110 may also comprise any suitable communication means to achieve the functionality of embodiments of the present invention. In one exemplary embodiment, the data link between the sensor pods 120 and the control module 110 allows for control of the sensor pods 120 in one direction, and acquisition data from the sensor pods 120 in the other direction. In such an embodiment, a bi-directional data link, such as a RS-485, LVDS, or PECL style interface with an 8b10b, 4b5b, or PCM protocol may be utilized.

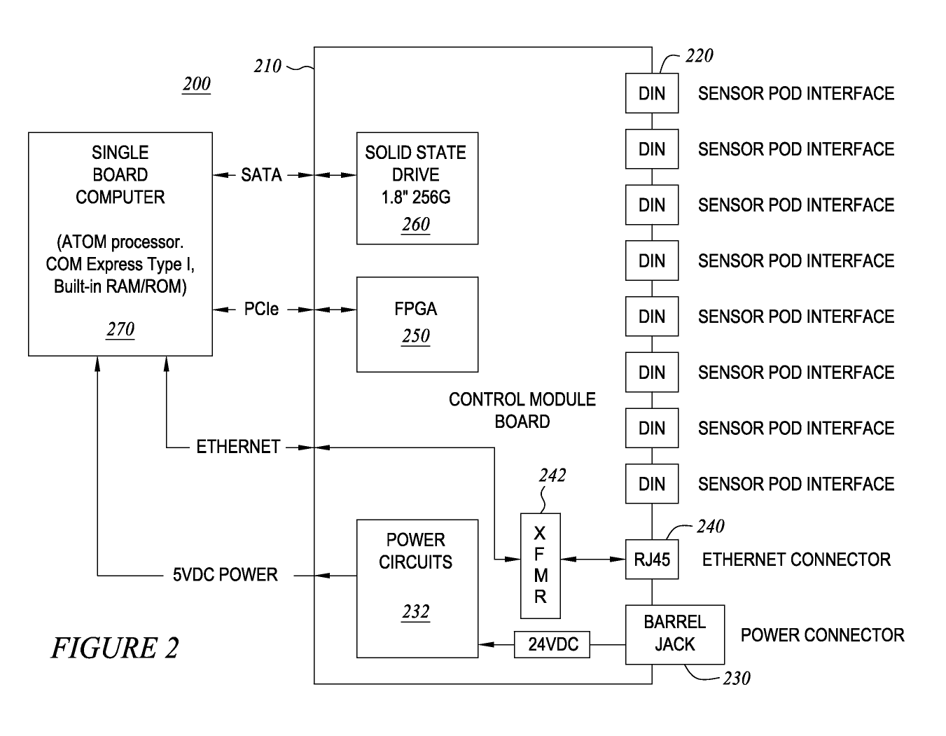

FIG. 2 depicts a control module in accordance with an embodiment of the present invention. As shown in the Figure, the control module 210 generally comprises an integrated circuit 250, a memory 260, at least one sensor pod interface 220, and a network connector 240 for communicating with an administrator (not shown). In some embodiments, the control module 210 further comprises a power connector 230 and power circuits 232 for sufficiently providing power to operate the control module 210. Optionally, the control module 210 may be in communication with a computer device 270 to assist in the processing of data obtained through the system 200. Although shown outside the control module 210, the computer device 270 may be encapsulated with the control module, depending on the nature of the application.

The sensor pod interfaces 220 may comprise any interface or connector suitable for embodiments of the present invention, which as discussed above with the data link, may be any type of known wired or wireless interface. In one exemplary embodiment, the sensor pod interfaces 220 comprise a DIN connector, or the like, and may connect with a compatible-type cable for creating bi-directional communication with the sensor pods (not shown). In many embodiments, the pods 120 obtain a sampling clock rate by extracting the clock from the data link to reduce the number of wires in the system.

The power connector 230 may generally comprise any type of power connector for retrieving power (i.e., voltage) from a power source (not shown) and allowing the power to be distributed through the control module 210 via the power circuits 232. Often, the power connector 230 is dependent upon the nature of the power source and the power consumption requirements of the control module 210. In one exemplary embodiment, the power connector 230 comprises a barrel jack, or similar DC voltage device.

The network connector 240 may comprise any type of connector suitable for allowing the control module 210 to remain in communication with an administrator (not shown). In many embodiments, the network connector 240 comprises a traditional Ethernet-type connection (i.e., utilizing an RJ-45 connector). In other embodiments, other commonly known network-based connectors may be utilized. The network connector 240 may be provided in communication with a transformer 242 for modifying the network data signals for sending to the computer device 270.

The integrated circuit 250, or IC, may comprise any type of IC commonly utilized in the computer industry, capable of performing the functions as required by embodiments of the present invention. In one embodiment of the present invention, the integrated circuit 250 comprises one of a field-programmable gate array (FPGA) having a peripheral component interconnect express (PCIe) for communication with the computer device 270.

The memory 260 comprises any type of memory for storing data, either historical data or data obtained from the sensors, in accordance with embodiments of the present invention. In many embodiments, the memory 260 comprises one of a solid-state drive (SSD) or a hard disk drive (HDD). In one exemplary embodiment, the memory 260 comprises a 256 GB SSD. The memory 260 is usually in communication with the computer device 270, using a computer bus interface (e.g., Serial Advanced Technology Attachment (SATA)), for transmitting stored data from the memory 260 and receiving new data to be stored in the memory 260.

The computer device 270 generally comprises a number of general computing components for processing data in accordance with embodiments of the present invention. Such general computing components are all well known in the industry, and as such, no further description thereof need be provided herein.

The computer device 270 may be any type of computer suitable for embodiments of the present invention. In one embodiment, the computer device 270 comprises a single-board computer, having a low-voltage processor, and built-in ROM/RAM. The computer device 270 may comprise a COM Express Type 1, or optionally a Type 2-5, depending on the processing needs of the application.

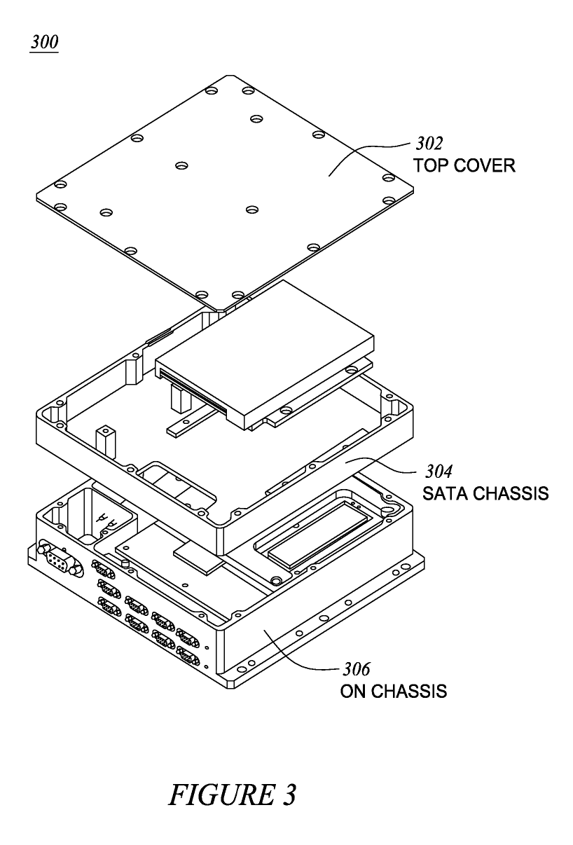

FIG. 3 depicts an exploded view of an exemplary control module in accordance with one embodiment of the present invention. As shown in the Figure, the control module 300 may generally be provided with a housing consisting of a top panel 302, a computer device chassis 304 and a control module chassis 306. As shown, when assembled, the components of the control module 300, including the computer device, are contained in a well-protected and sealed housing, to protect the components from environmental conditions.

In many embodiments, the control module 300 may be required to withstand significant changes in temperature (e.g., from about −40 degrees Celsius to about 80 degrees Celsius). Similarly, the control module 300 may be required to withstand shock and vibration forces up to about 15G peak-to-peak, 11 ms duration during non-operation, up to 1.88 Grms, 5-500 Hz in each axis during non-operation, and 0.5 Grms, 5-500 Hz in each axis during operation of the system.

Embodiments of the present invention are designed to be implemented on an aeronautic system, such as a jet, an airliner, a cargo aircraft, a turboprop plane, a twin piston engine plane, a helicopter, a space shuttle, or the like, commonly referenced collectively as “aircrafts.” Specifically, embodiments of the present invention are designed to place the sensors, described herein, and monitor components within the aeronautic system, such as on any mechanical component utilized to allow the aeronautic system to properly function.

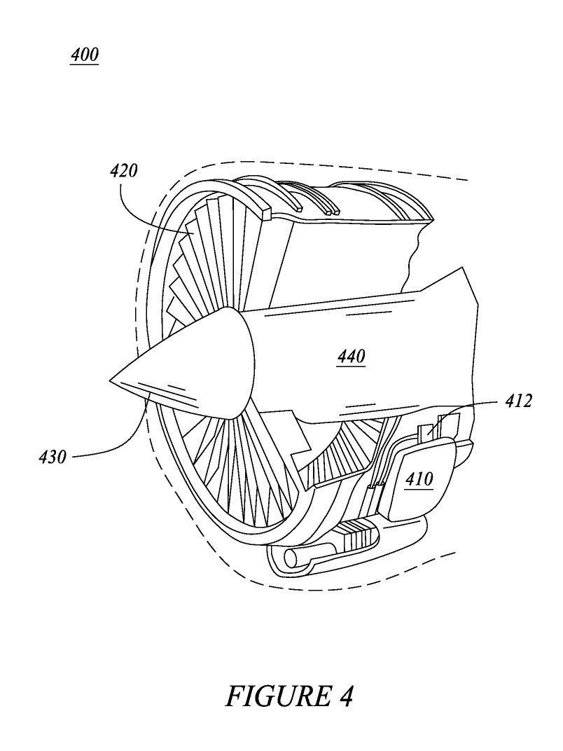

FIG. 4 depict a perspective view of a jet engine, having a prognostic health monitoring system embedded therein, in accordance with one embodiment of the present invention. Although components of a jet engine are known, for purposes of simplicity, as shown, the jet engine 400 generally comprises a fan 420, a nozzle 430 and a shaft 440. Although many other components are required for a jet engine to function, the present example can be sufficiently demonstrated utilizing the components shown.

A control module 410 may be provided proximate the jet engine 400, provided it can remain in communication with an administrator through the network as described above. Often, one or more sensors 412 are strategically positioned on components sought to be monitored. For example, in one embodiment, sensors 412 may be positioned on a fan 420, a compressor (not shown), a shaft 440, a combustion chamber (not shown), a turbine (not shown), a nozzle 430, a fuel injector (not shown), combinations thereof, or the like. For purposes of embodiments of the present invention, given the complex nature of components of aeronautical systems, nearly every component within such a system may be monitored and diagnosed in accordance with the systems and methods described herein.

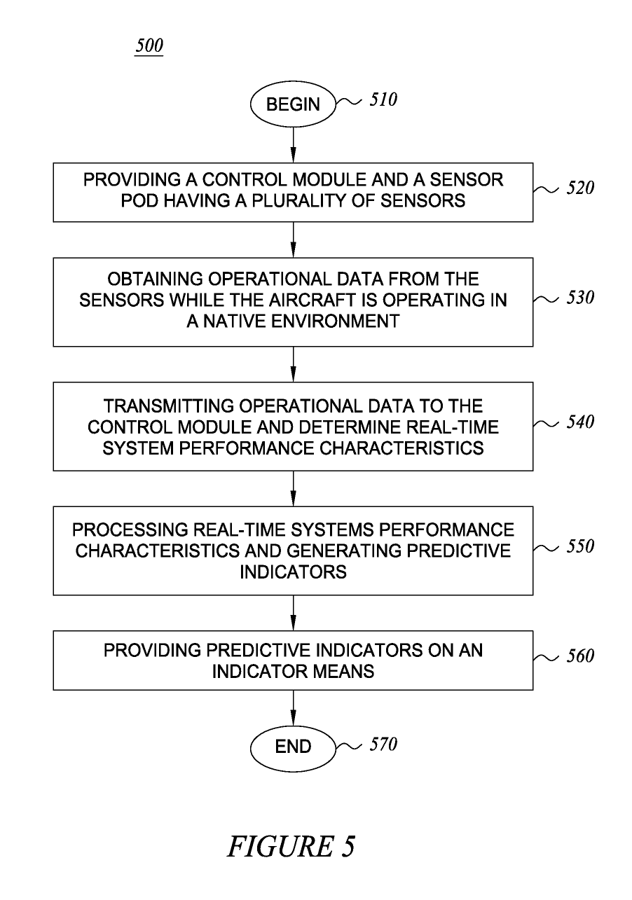

FIG. 5 depicts a flowchart of a method of operation of an embedded prognostic health management system for aeronautical machines in accordance with embodiments of the present invention. The method 500 begins at step 510. I

At step 520, a control module in communication with a sensor pod having a plurality of sensors, as described herein, is provided, and the sensors are physically positioned on mechanical components of an aircraft. In many embodiments, the physical positioning of the sensor pod and the sensors is strategically implemented based on the minimum proximity to a location within the operating temperature range of the pod 120. In some aeronautical applications, the positioning of the sensor pods should be within about 30 feet of the sensors, to yield improved results having minimal noise and interference.

Once the components are in place, at step 530, the sensors are able to obtain operational data regarding the component(s) of the aircraft while the aircraft is in a “native environment,” e.g., flying, taking-off, landing, etc. Depending on the nature of the sensor, the operational data obtained from the sensor will generally comprise an electronic signal. In many embodiments, the operational data is an analog signal.

At step 540, the operational data obtained from the sensors is transmitted to the control module through the sensor pods. In many embodiments, the sensor pods convert an analog operational data signal to a digital signal utilizing an analog-to-digital converter (A/D). At the control module, once the signal is received, the control module can determine real-time system performance characteristics of the component of the aeronautical system. In many embodiments, the signal (which may generally be in the form of a binary number) is indicative of a particular common attribute for the component. For example, if the component is a rotational shaft within a jet engine, a signal received may be indicative of the rotational speed, vibration or torque of the shaft by comparing the signal against known data for such measurement. Such corollary relationships may generally be stored by the memory within the control module.

In some embodiments, the system may be in communication with old types of transducer-based measurement systems of components of the aircraft. For example, common gauges, FADEC systems, ODB-II systems, or the like, may also be tapped into for additional information regarding the operation of certain components. Depending on the nature of the information obtained, the computer device may factor in such readings when determining the real-time system performance characteristics.

At step 550, utilizing the computer device, the control module processes the real-time system performance characteristics against a set of historical records containing past system performance characteristics. By making such comparisons between data and based on known end results of past system performance characteristics, the computer device can determine likely results or “predictive indicators” for the current component operating with its real-time system performance characteristics. Such predictive indicators may be utilized for forecasting remaining component lifetime and future component failures.

At step 560, the information regarding the real-time system performance characteristics and the associated predictive indicators are presented to the administrator and/or other third parties. Generally, such information is presented on an indicator means, which may comprise any type of audio, visual, textual, tactile, or other form of communication feasible within the context of embodiments of the present invention. In one embodiment, the indicator means may comprise a monitor and speaker combination, whereby the information may be presented in a visual and/or audio format. Similarly, the information may be presented to the pilot or other individual flying in, controlling or otherwise associated with the aircraft. Such information may be displayed on any number of types of gauges or meters, as commonly found in an aircraft.

In further embodiments of the present invention, the indicator means may comprise a web-based or network-based application (e.g., through the network, commercial cellular, satellite, application-dictated telemetry infrastructures), whereby persons may access the information being presented by the system through any convenient access medium (e.g., a computer terminal, a mobile smartphone, or the like). In such an embodiment, a third party maintenance company, monitoring company or supervisory management system may also be able to monitor the servicing needs of the aircraft and determine systemic issues across the entire engine fleet.

Optionally, in some embodiments, the system may be in communication with the aircraft's control computers which provide control over most, if not all, of the components of the aircraft. In such an embodiment, depending on the nature of a predictive indicator received, the system may generate real-time control signals to actively limit a range of use parameter to enforce operational safety limitations. For example, if the predictive indicators sense an immediate failure unless speed is reduced, the system may override the controls of the aircraft and reduce the component to the necessary speed to avoid immediate failure. Exemplary types of control parameters may include: maximum speed, maximum rotation, maximum fluid intake or the like. In many embodiments, such control overriding may be done by communicating through an already existing on-board system, such as the FADEC.

While the foregoing is directed to embodiments of the present invention, other and further embodiments of the invention may be devised without departing from the basic scope thereof. Furthermore, whereas the multitude of embodiments disclosed herein each provides a variety of elements within each embodiment, it should be appreciated any combination of elements from any combination of embodiments is well within the scope of further embodiments of the present invention.

What is claimed is:

1. A method of maintaining prognostic health management accuracy of an aeronautic system comprising:
providing a control module and a sensor pod having a plurality of sensors, and physically positioning the plurality of sensors on a mechanical component of an aircraft;
obtaining operational data from the sensors while the aircraft is operating in a native environment;
transmitting operational data to the control module and determine real-time system performance characteristics;
processing real-time system performance characteristics against a set of historical records containing past system performance characteristics and generating predictive indicators for forecasting remaining component lifetime and future component failures; and
providing predictive indicators on an indicator means.

2. The method of claim 1, further comprising:
generating real time control signals to actively limit a range of use parameter to enforce operational safety limitations.

3. The method of claim 2, wherein the range of use parameter comprises one of a maximum speed, maximum rotation, maximum fluid intake or combinations thereof.

4. The method of claim 1, further comprising:
reporting predictive indicators to at least one external supervisory management system.

5. The method of claim 4, wherein the reporting predictive indicators to at least one external supervisory management system occurs through an integration of at least one of commercial cellular, satellite, application-dictated telemetry infrastructures or combinations thereof.

6. The method of claim 1, wherein the aircraft comprises one of a jet, an airliner, a cargo aircraft, a turboprop plane, a twin piston engine plane, a helicopter or a space shuttle.

7. The method of claim 1, wherein the mechanical component comprises a component of a jet engine.

8. The method of claim 7, wherein the mechanical component comprises one of a fan, a compressor, a shaft, a combustion chamber, a turbine, a nozzle or a fuel injector.

9. The method of claim 1, wherein the operational data comprises data relating to rotational speed, vibration, torque, or combinations thereof, of the mechanical component.

10. The method of claim 1, further comprising:
interfacing with an existing traditional transducer-based measurement system and obtaining traditional data therefrom.

11. The method of claim 10, further comprising:
combining the traditional data with the operational data to assist in determining the real-time system performance characteristics.

12. The method of claim 1, wherein determining real-time system performance characteristics comprises applying the data to established computer-implemented modeling techniques and comparing the resulting data to historical records containing past system performance characteristics.

13. The method of claim 1, wherein the indicator means comprises one of a visual monitor, an audible speaker, or combinations thereof.

14. A method of maintaining prognostic health management accuracy of a jet comprising:
providing a control module and a sensor pod having a plurality of sensors, and physically positioning the plurality of sensors on a mechanical component of a jet engine;
obtaining operational data from the sensors while the jet is operating in a native environment;
interfacing with an existing traditional transducer-based measurement system and obtaining traditional data therefrom;
transmitting operational data and traditional data to the control module and determine real-time system performance characteristics;
processing real-time system performance characteristics against a set of historical records containing past system performance characteristics and generate predictive indicators for forecasting remaining component lifetime and future component failures;
provide predictive indicators on an indicator means;
generating real time control signals to actively limit a range of use parameter to enforce operational safety limitations; and
reporting predictive indicators to at least one external supervisory management system.

15. The method of claim 14, wherein the range of use parameter comprises one of a maximum speed, maximum rotation, maximum fluid intake or combinations thereof.

16. The method of claim 14, wherein the reporting predictive indicators to at least one external supervisory management system occurs through an integration of at least one of commercial cellular, satellite, application-dictated telemetry infrastructures or combinations thereof.

17. The method of claim 14, wherein the mechanical component of the jet engine comprises one of a fan, a compressor, a shaft, a combustion chamber, a turbine, a nozzle or a fuel injector.

18. The method of claim 14, wherein the operational data comprises data relating to rotational speed, vibration, torque, or combinations thereof, of the mechanical component.

19. The method of claim 14, wherein the indicator means comprises one of a visual monitor, an audible speaker, or combinations thereof.

20. A system for maintaining prognostic health management accuracy of an aeronautic system comprising:
a control module in communication with a sensor pod, the sensor pod having a plurality of sensors positioned on a mechanical component of an aircraft; and
a set of executable instructions stored within a memory in the control module, the set of executable instructions for:
obtaining operational data from the sensors while the aircraft is operating in a native environment;
transmitting operational data to the control module and determine real-time system performance characteristics;
processing real-time system performance characteristics against a set of historical records containing past system performance characteristics and generating predictive indicators for forecasting remaining component lifetime and future component failures; and
providing predictive indicators on an indicator means.
